(19) United States
(12) Patent Application Publication
(10) Pub. No.: US 2003/0003341 A1
(43) Pub. Date: Jan. 2, 2003

(54) Liquid fuel cell reservoir for water and/or fuel management

(76) Inventors: Mark R. Kinkelaar, Glenmoore, PA (US); Andrew M. Thompson, West Chester, PA (US)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 09/897,782

(22) Filed: Jun. 29, 2001

(51) Int. Cl. H01M 8/02; H01M 8/10

(52) U.S. Cl. 429/34; 429/30; 429/41

(57) ABSTRACT

Water recovery in direct liquid fuel cells, particularly direct methanol fuel cells, is accomplished by incorporating a reservoir structure composed of a wicking material, which may be a composite material, adjacent to the cathode. The wicking material has a free rise wick height of at least one half its longest dimension. The wicking materials may be selected from foams, bundled fibers and nonwoven fibers. In one embodiment, holes or perforations are formed through the thickness of the sheet, and a conductive layer is adjacent to, adhered to or coated on at least one surface of the wicking material. To recycle water, a second reservoir structure of wicking material is incorporated adjacent to the anode, and a liquid flow path is provided between the first and second reservoir structures. The absorbed water flows through the liquid flow path, is mixed with fuel and introduced to the second reservoir structure adjacent to the anode.

This invention relates to liquid fuel cells in which the liquid fuel is directly oxidized at the anode. In particular, it relates to reservoir structures adjacent the cathode to collect discharged water and reservoir structures adjacent the anode to meter liquid fuel/water mixtures to the anode in direct methanol fuel cells. The invention also relates to a water recovery and recycling system to deliver recovered water to a fuel cell or a micro fuel cell reformer.

### BACKGROUND OF THE INVENTION

Electrochemical fuel cells convert reactants, namely fuel and oxidants, to generate electric power and reaction products. Electrochemical fuel cells generally employ an electrolyte disposed between two electrodes (an anode and a cathode). An electrocatalyst is needed to induce the desired electrochemical reactions at the electrodes. Solid polymer fuel cells operate in a temperature range of from about 020 C. to the boiling point of the fuel, i.e., for methanol about 65° C., or the boiling point of the fuel mixture, and are particularly preferred for portable applications. Liquid feed solid polymer fuel cells include a membrane electrode assembly (“MEA”), which comprises a solid polymer electrolyte or proton-exchange membrane, sometimes abbreviated “PEM”, disposed between two electrode layers. Flow field plates for directing the reactants across one surface of each electrode are generally disposed on each side of the membrane electrode assembly. These plates may also be called the anode backing and cathode backing.

A broad range of reactants have been contemplated for use in solid polymer fuel cells, and such reactants may be delivered in gaseous or liquid streams. The oxidant stream may be substantially pure oxygen gas, but preferably a dilute oxygen stream such as found in air, is used. The fuel stream may be substantially pure hydrogen gas, or a liquid organic fuel mixture. A fuel cell operating with a liquid fuel stream wherein the fuel is reacted electrochemically at the anode (directly oxidized) is known as a direct liquid feed fuel cell.

A direct methanol fuel cell (“DMFC”) is one type of direct liquid feed fuel cell in which the fuel (liquid methanol) is directly oxidized at the anode. The following reactions occur:

Anode: CH₃OH+H₂O→6H⁺+CO₂+6e⁻

Cathode: 1.5O₂+6H⁺+6e⁻→3H₂O

The hydrogen ions (H⁺) pass through the membrane and combine with oxygen and electrons on the cathode side producing water. Electrons (e⁻) cannot pass through the membrane, and therefore flow from the anode to the cathode through an external circuit driving an electric load that consumes the power generated by the cell. The products of the reactions at the anode and cathode are carbon dioxide (CO₂) and water (H₂O), respectively. The open circuit voltage from a single cell is about 0.7 volts. Several direct methanol fuel cells are stacked in series to obtain greater voltage.

Other liquid fuels may be used in direct liquid fuel cells besides methanol—i.e., other simple alcohols, such as ethanol, or dimethoxymethane, trimethoxymethane and formic acid. Further, the oxidant may be provided in the form of an organic fluid having a high oxygen concentration—i.e., a hydrogen peroxide solution.

A direct methanol fuel cell may be operated on aqueous methanol vapor, but most commonly a liquid feed of a diluted aqueous methanol fuel solution is used. It is important to maintain separation between the anode and the cathode to prevent fuel from directly contacting the cathode and oxidizing thereon (called “cross-over”). Cross-over results in a short circuit in the cell since the electrons resulting from the oxidation reaction do not follow the current path between the electrodes. To reduce the potential for cross-over of methanol fuel from the anode to the cathode side through the MEA, very dilute solutions of methanol (for example, about 5% methanol in water) are typically used as the fuel streams in liquid feed DMFCs.

The polymer electrolyte membrane (PEM) is a solid, organic polymer, usually polyperfluorosulfonic acid that comprises the inner core of the membrane electrode assembly (MEA). Commercially available polyperfluorosulfonic acids for use as PEMs are sold by E. I. DuPont de Nemours & Company under the trademark NAFION®. The PEM must be hydrated to function properly as a proton (hydrogen ion) exchange membrane and as an electrolyte.

Substantial amounts of water are liberated at the cathode and must be removed so as to prevent flooding the cathode and halting the reaction. In prior art fuel cells, if the air flow past the cathode is too slow, the air cannot carry all of the water present at the cathode out of the fuel cell. With water flooding the cathode, not enough oxygen is able to penetrate past the water to reach the cathode catalyst sites to maintain the reaction.

Prior art fuel cells incorporated porous carbon paper or cloth as backing layers adjacent the PEM of the MEA. The porous carbon materials not only helped to diffuse reactant gases to the electrode catalyst sites, but also assisted in water management. Porous carbon was selected because carbon conducts the electrons exiting the anode and entering the cathode. However, porous carbon has not been found to be an effective material for wicking excess water away from the cathode. Nor has porous carbon been found effective to meter fluid to the anode. And porous carbon paper is expensive. Consequently, the fuel cell industry continues to seek backing layers that will improve liquid recovery and removal, and maintain effective gas diffusion, without adversely impacting fuel cell performance or adding significant expense.

It would also be advantageous to recycle the water liberated at the cathode for use as the diluent in the liquid fuel delivery system. Such recycled water could be mixed with concentrated methanol before introducing the liquid fuel to the fuel cell. Substantial space and weight savings would result if fuel cartridges contained predominantly methanol, and that methanol could then be diluted to an aqueous solution of from about 3 to 5% methanol concentration using recycled water emitted by the fuel cell reaction. The fuel cartridge carried with the fuel cell containing predominantly methanol could be smaller and lighter weight. A material that can wick the excess water away from the cathode must also be able to release the collected water for recycling into the liquid fuel. Prior art carbon paper backing layers do not meet these competing criteria.

While the prior art has identified recycling the liberated water to mix with pure methanol before introducing the liquid fuel into the direct methanol liquid fuel cell as one goal for improving fuel cell performance, there is no disclosure of an effective means of recovering and recycling such water independent of fuel cell orientation. The problem is particularly acute for fuel cells intended to be used in portable applications, such as in consumer electronics and cell phones, where the fuel cell orientation with respect to gravitational forces will vary.

### SUMMARY OF THE INVENTION

According to a first embodiment of the invention, a reservoir structure is installed substantially adjacent to a cathode or an anode of a liquid fuel cell. The reservoir structure is a sheet of wicking material into which a liquid wicks and from which said liquid subsequently may be metered. The reservoir structure thus not only wicks and retains liquids, but permits liquids to be controllably metered out from such structure.

The reservoir structure has a geometry having a longest dimension. For a cylindrical shaped reservoir structure, the longest dimension may be either its height or its diameter, depending upon the relative dimensions of the cylinder. For a rectangular box-shaped reservoir structure, the longest dimension may be either its height or its length or its thickness, depending upon the relative dimensions of the box. For other shapes, such as a square box-shaped reservoir, the longest dimension may be the same in multiple directions. The free rise wick height (a measure of capillarity) of the reservoir structure preferably is greater than at least one half of the longest dimension. Most preferably, the free rise wick height is greater than the longest dimension.

The reservoir structure may be made from foams, bundled fibers or nonwoven fibers. Preferably, the reservoir structure is constructed from a material selected from the group consisting of polyurethane foam, felted polyurethane foam, reticulated polyurethane foam, felted reticulated polyurethane foam, melamine foam, nonwoven felts or bundles of nylon, polypropylene, polyester, cellulose, polyethylene terephthalate, polyethylene, polypropylene and polyacrylonitrile, and mixtures thereof.

A felted foam is produced by applying heat and pressure sufficient to compress the foam to a fraction of its original thickness. For a compression ratio of 30, the foam is compressed to 1/30 of its original thickness. For a compression ratio of 2, the foam is compressed to ½ of its original thickness.

A reticulated foam is produced by removing the cell windows from the cellular polymer structure, leaving a network of strands and thereby increasing the fluid permeability of the resulting reticulated foam. Foams may be reticulated by in situ, chemical or thermal methods, all as known to those of skill in foam production.

In a particularly preferred embodiment, the reservoir structure is made with a wicking material with a gradient capillarity, such that the flow of the liquid is directed from one region of the structure to another region of the structure as a result of the differential in capillarity between the two regions. One method of producing a foam with a gradient capillarity is to felt the foam to varying degrees of compression along its length. The direction of capillarity flow of liquid is from a lesser compressed region to a greater compressed region. Alternatively, the reservoir structure may be made of a composite of individual components of foams or other materials with distinctly different capillarities.

Because it is important to have gases (air or oxygen) reach the active sites at the cathode, the reservoir structure may be formed so as to increase air permeability. Hence, if the reservoir structure is a sheet of wicking material, the sheet may define one or more holes through its thickness. Such holes may be formed by perforating or punching the sheet. The holes may be formed in a regular grid pattern or in an irregular pattern. Alternatively, the sheet may define a one or more channels formed in a facing surface. The channels may be formed by cutting, such as by surface modification or convolute cutting as known in the foam fabrication industry. The channels or holes may also be formed using thermo-forming techniques in which the surface of the sheet is contoured under applied heat and pressure.

Because it is important to have a conductive path for electrons to reach the active sites at the cathode, the reservoir structure preferably further comprises a conductive layer either adjacent to or connected to or coated on the wicking material forming the reservoir structure. The conductive layer may be a metal screen, a metal wool, or an expanded metal foil. In a preferred embodiment, the conductive layer is attached to a surface of the sheet of wicking material forming the reservoir structure, such as by crimping the conductive layer around the sheet. Alternatively, the conductive layer may be a coating coated onto a surface of the sheet or penetrating through the entire thickness of the sheet. Such coatings include metals, carbons and carbon-containing materials, conductive polymers and suspensions or mixtures thereof. Metals may be coated using vapor deposition, plasma, arc and electroless plating techniques, or any other suitable coating technique. In another preferred embodiment, the front and at least a portion of the back surface of a sheet of wicking material is covered with the conductive layer. When the conductive layer is crimped around the sheet, the conductive layer covers also the top and bottom edges of the sheet. The conductive layer is in communication with a current circuit.

The invention also includes a water recovery system for a direct methanol fuel cell having (a) a reservoir structure into which water wicks and from which said water may be metered installed as a backing layer for a cathode in the fuel cell, said reservoir structure having a longest dimension and a free rise wick height greater than at least one half of the longest dimension; (b) a liquid flow path in communication with the reservoir structure through which absorbed water from the reservoir structure flows away from the reservoir structure; and (c) a pump to draw absorbed water from the reservoir structure and into the liquid flow path. Water absorbed by the reservoir structure is drawn away from the cathode and pumped or directed to a reservoir or channel to be mixed with liquid fuel prior to its introduction to the anode side of the fuel cell.

The reservoir structure in the water recovery system is made from a wicking material selected from the group consisting of foam, bundled fiber and nonwoven fiber. Preferably, the reservoir structure has a conductive layer associated therewith, which may be a separate layer adjacent to the wicking material or may be attached or coated thereon. The conductive layer is in communication with a current circuit.

In a preferred embodiment, a second reservoir structure is installed as the backing layer for an anode in the fuel cell. The second reservoir structure may have the same or different construction from the first reservoir structure. The second reservoir structure has a longest dimension and a free rise wick height greater than at least one half of its longest dimension, preferably greater than its longest dimension. The recovered and recycled water mixed with the liquid fuel is directed to the second reservoir structure to re-fuel the liquid fuel cell reaction at the anode.

In another embodiment of the invention, liquid fuel cell performance is improved by incorporating as a backing layer for the cathode, and optionally as a backing layer for the anode, the reservoir structure of the first embodiment of the invention. Because the reservoir structure efficiently and effectively wicks water away from the cathode, the reaction continues without flooding caused by the water emitted by the fuel cell. The absorbed collected water may be recycled and mixed with a source of liquid fuel before re-introducing it to the anode side of the fuel cell. Preferably the recycled water mixed with fuel is introduced to a reservoir structure forming a backing layer for the anode. This second reservoir structure when so wetted with the recycled water and fuel helps both to distribute the fuel and to keep the PEM hydrated.

### DESCRIPTION OF THE FIGURES

FIG. 1 is schematic view in side elevation of a direct methanol fuel cell incorporating the reservoir structures according to the invention;

FIG. 2 is a top plan view of a first embodiment of a reservoir structure according to the invention that includes a perforated sheet covered with a metal screen;

FIG. 3 is a top plan view of a second embodiment of a reservoir structure according to the invention that includes a sheet without perforations covered with a metal screen;

FIG. 4 is a left side elevational view of the reservoir structure of FIG. 3;

FIG. 5 is a top plan view of a third embodiment of a reservoir structure according to the invention that includes a perforated sheet without a metal screen covering;

FIG. 6 is a right side elevational view of the reservoir structure of FIG. 5, wherein the view is partially broken away to show the perforations extending through the sheet;

FIG. 7 is a top plan view of a fourth embodiment of a reservoir structure according to the invention that lacks perforations and lacks a metal screen covering;

FIG. 8 is a top plan view of a fifth embodiment of a reservoir structure according to the invention having channels;

FIG. 9 is a left side elevational view of the reservoir structure of FIG. 8;

FIG. 10 is a schematic diagram of a wedge of wicking material prior to felting; and

FIG. 11 is a schematic diagram of the wicking material of FIG. 10 after felting.

### DESCRIPTION OF THE PREFERRED EMBODIMENTS

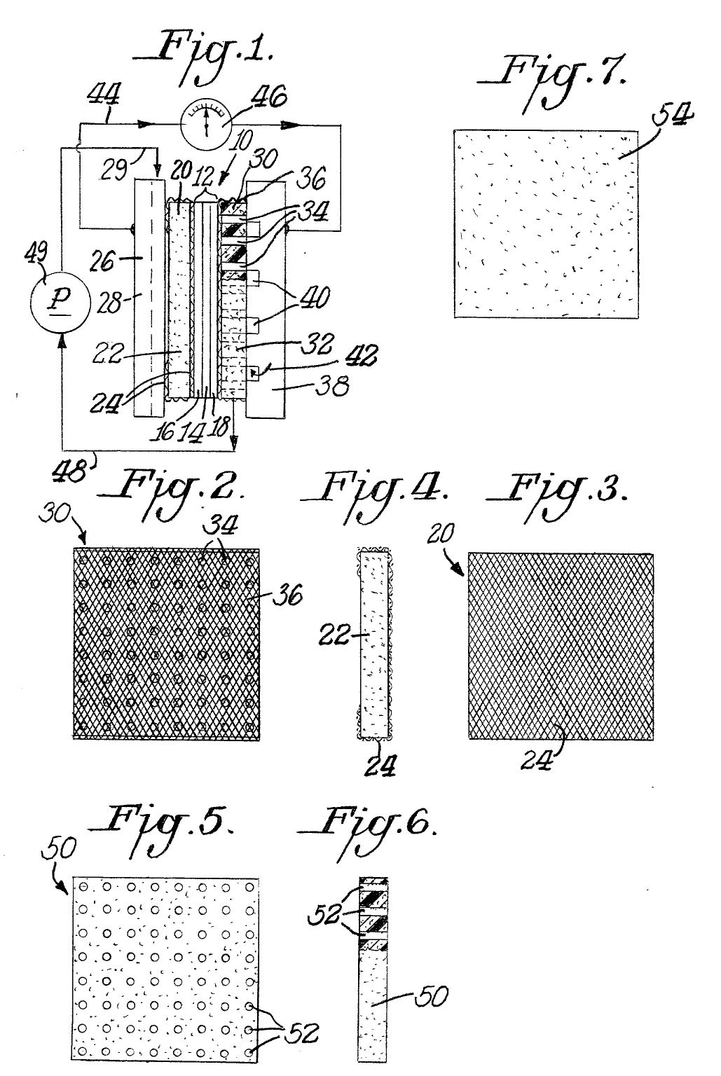

Referring first to FIG. 1, a direct methanol fuel cell 10 includes a membrane electrode assembly (“MEA”) 12 comprising a polymer electrolyte membrane (“PEM”) 14 sandwiched between an anode 16 and a cathode 18. The PEM 14 is a solid, organic polymer, usually polyperfluorosulfonic acid that comprises the inner core of the membrane electrode assembly (MEA). Commercially available polyperfluorosulfonic acids for use as a PEM are sold by E. I. DuPont de Nemours & Company under the trademark NAFION®. Catalyst layers (not shown) are present on each side of the PEM. The PEM must be hydrated to function properly as a proton (hydrogen ion) exchanger and as an electrolyte.

The anode 16 and cathode 18 are electrodes separated from one another by the PEM. The anode carries a negative charge, and the cathode carries a positive charge.

Adjacent to the anode is provided a reservoir structure 20 formed from a 12 mm thick sheet 22 of 85 pore reticulated polyether polyurethane foam that has been felted, or compressed, to one sixth of its original thickness (2 mm). See also FIGS. 3 and 4. The felted foam is cut to size, and a thin, expanded metal foil 24 is partially wrapped around the sheet, so as to cover the entire MEA side of the sheet 22. The expanded metal foil we used was Delker 1.5Ni5-050F nickel screen. As shown in FIG. 1, the foil 24 wraps around the top and bottom edges of the foam sheet 22 so that a portion of the foil also contacts the side of the sheet facing away from the MEA 12. The foil 24 is crimped in place on the sheet 22. The reservoir structure 20 will wick and collect water and will collect current. It helps to distribute the liquid fuel and on the anode side of the fuel cell, and helps to hydrate the PEM 14.

In the direct methanol fuel cell of FIG. 1, the fuel may be liquid methanol or an aqueous solution of methanol mixed with water, wherein methanol comprises from 3 to 5% of the solution. Other liquid fuels providing a source of hydrogen ions may be used, but methanol is preferred.

Adjacent to the reservoir structure 20 is bipolar plate 26. Bipolar plate 26 is an electrical conductive material and has formed therein channels 28 for directing the flow of liquid fuel to the anode side of the fuel cell. Arrow 29 indicates the direction of the flow of liquid fuel into the channels 28 in bipolar plate 26.

Adjacent to the cathode 18 is provided a second reservoir structure 30 formed from a 12 mm thick sheet 32 of 85 pore reticulated polyether polyurethane foam that has been felted, or compressed, to one sixth of its original thickness (2 mm). See also FIG. 2. The felted foam is perforated with a regular square grid pattern of holes with a diameter of 0.5 mm each, leaving a perforation void volume of approximately 18% in the sheet. The felted foam is then cut to size and a thin, expanded metal foil 36 (Delker 1.5Ni5-050F nickel screen) is partially wrapped around the sheet, so as to cover the entire MEA side of the sheet 32. As shown in FIG. 1, the foil 36 wraps around the top and bottom edges of the foam sheet 32 so that a portion of the foil 36 also contacts the side of the sheet facing away from the MEA 12. The second reservoir structure 30 will wick and collect water and will collect current. It helps to remove water from the cathode side of the fuel cell to prevent flooding, and allows air to contact the cathode side to ensure oxygen continues to reach the active sites.

Adjacent to the second reservoir structure 30 is a bipolar plate 38. Bipolar plate 38 is an electrical conductive material and has formed therein channels 40 for directing the flow of oxidizing gas, such as oxygen or air, to the cathode side of the fuel cell 10. Arrow 42 indicates the flow of gas into one of the channels 40 in the bipolar plate 38.

In operation, the liquid fuel (methanol) 29 reacts at the surface of the anode to liberate hydrogen ions (H⁺) and electrons (e⁻). The hydrogen ions (H⁺) pass through the PEM 14 membrane and combine with oxygen 42 and electrons on the cathode side producing water. Electrons (e⁻) cannot pass through the membrane and flow from the anode to the cathode through an external circuit 44 containing an electric load 46 that consumes the power generated by the cell. The products of the reactions at the anode and cathode are carbon dioxide (CO₂) and water (H₂O), respectively.

The reservoir structure 30 collects the water produced at the cathode 18 and wicks it away from the reactive sites on the cathode. The water may then be carried through liquid flow path 48, which may be piping or tubing to a reservoir or mixing point for mixing with pure liquid fuel to form an aqueous liquid fuel solution. Due to the capillary action of the reservoir structure, which holds liquid within voids or pores in that structure, pumping or drawing forces must be applied to draw the water from the second reservoir structure 30 into the liquid flow path 48. Pump 49 is one means for drawing water out of the reservoir structure 30 for recycling with the liquid fuel supply. A particularly preferred pump is a micro-dose dispensing pump or micropump, that will pump 0.8 microliters per pulse, such as is available from Pump Works, Inc. Alternative pumping means are readily apparent to those of skill in the art.

The reservoir structures according to the invention have a thickness in the range of 0.1 to 10 mm, preferably from 0.5 to 4.0 mm, and most preferably less than about 2.0 mm.

The reservoir structures are formed from wicking materials of foam, bundled fiber and nonwoven fiber, or combinations of these materials. The following materials are particularly preferred: polyurethane foam, felted polyurethane foam, reticulated polyurethane foam, felted reticulated polyurethane foam, melamine foam, nonwoven felts or bundles of nylon, polypropylene, polyester, cellulose, polyethylene terephthalate, polyethylene, polypropylene and polyacrylonitrile, and mixtures thereof.

If a polyurethane foam is selected for the reservoir structure, such foam should have a density in the range of 0.5 to 25 pounds per cubic foot, and pore sizes in the range of 10 to 200 pores per linear inch, preferably a density in the range of 0.5 to 15 pounds per cubic foot and pore sizes in the range of 40 to 200 pores per linear inch, most preferably a density in the range of 0.5 to 10 pounds per cubic foot and pore sizes in the range of 75 to 200 pores per linear inch.

Felting is carried out under applied heat and pressure to compress a foam structure to an increased firmness and reduced void volume. Once felted, the foam will not rebound to its original thickness, but will remain compressed. Felted foams generally have improved capillarity and water holding than unfelted foams. If a felted polyurethane foam is selected for the reservoir structure, such foam should have a density in the range of 2.0 to 45 pounds per cubic foot and a compression ratio in the range of 1.1 to 30, preferably a density in the range of 3 to 15 pounds per cubic foot and compression ratio in the range of 1.1 to 20, most preferably a density in the range of 3 to 15 pounds per cubic foot and compression ratio in the range of 2.0 to 15.

The conductive layer associated with the sheet of wicking material to form the preferred embodiments of the reservoir structure may be a metal screen or an expanded metal foil or metal wool. Exemplary metals for this application are gold, platinum, nickel, stainless steel, tungsten, rhodium, cobalt, titanium, silver, copper, chrome, zinc, iconel, and composites or alloys thereof. Metals that will not corrode in moist environments will be suitable for the conductive layer. The conductive layer might also be a conductive carbon coating or a paint or coating having conductive particles dispersed therein.

As shown in FIGS. 1-4, the metal foil is crimped around the sheet of wicking material. Alternatively, the conductive layer may be connected or attached to the surface of the wicking material. If the wicking material is a foam and the conductive layer is a metal substrate, the conductive layer may be laminated directly to the surface of the foam without adhesives. For example, the surface of the foam may be softened by heating and the conductive layer applied to the softened foam surface. Alternatively, the conductive layer may be compressed into the foam when the foam is felted. If the conductive layer is formed with a coating, the coating may be applied to the wicking material by various methods known to those skilled in the art, such as painting, vapor deposition, plasma deposition, arc welding and electroless plating.

One advantage of the reservoir structures according to the invention is that they not only will wick and hold liquids, but also will release and permit liquids to be metered therefrom in a predictable manner without reliance on or interference from gravitational forces. The capillary action of the wicking material can be controlled, such that the reservoir structure will perform regardless of orientation with respect to gravity. Such reservoir structures are ideal for use in fuel cells to power portable electronic equipment, such as cell phones, which do not remain in a fixed orientation during use.

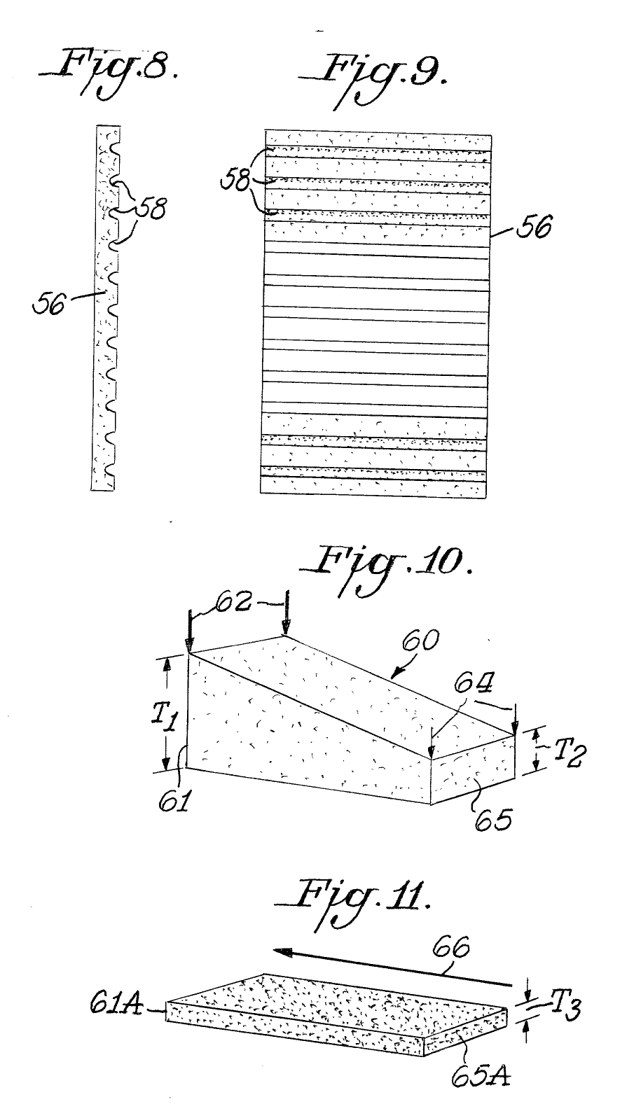

FIGS. 5 and 6 show an alternative reservoir structure 50 for use on the cathode side of the liquid fuel cell. A 12 mm thick 85 pore reticulated polyether polyurethane foam is permanently compressed to one-sixth of its original thickness (2 mm) (compression ratio=6). The felted foam is perforated with a regular square grid pattern of holes 52 with a diameter of 0.5 mm each, leaving a void volume of approximately 18% in the sheet. While this embodiment lacks a conductive layer or coating, the reservoir structure 50 will wick and collect water from the cathode side of the liquid fuel cell and will also permit oxygen source gas to contact the cathode side of the MEA through the perforations 52 to prevent flooding.

FIG. 7 shows an alternative reservoir structure 54 for use on the anode or cathode side of the liquid fuel cell. A 12 mm thick 85 pore reticulated polyether polyurethane foam is felted (permanently compressed) to one-sixth of its original thickness (2 mm) (compression ratio=6). The open structure having voids between the strands of the foam, which permit fluid to flow therein due to the reticulation, will wick and hold water or liquid fluid or a liquid fluid aqueous solution. While this embodiment lacks a conductive layer or coating, the reservoir structure 54 will wick and collect water from the cathode side of a liquid fuel cell. If installed on the anode side, this embodiment will distribute and hold liquid fuel, and help to hydrate the PEM.

FIGS. 8 and 9 show one configuration for a sheet 56 of wicking material formed with channels 58. The channels 58 are shown in a regular, parallel array, but may be provided in alternative configurations as suited to the application. The channels provide gaps for increased air flow. The wicking material may include a combination (not shown) of channels and holes or perforations to further increase air flow to the electrodes in the fuel cell, particularly the cathode. This wicking material alone may form a reservoir structure, or may be combined with a conductive layer (not shown in FIGS. 8 and 9).

FIGS. 10 and 11 illustrate schematically the method for making a wicking material, such as a foam, with a gradient capillarity. As shown in FIG. 10, a wedge-shaped slab 60 of foam of consistent density and pore size has a thickness T1 at a first end 61 and a second thickness T2 at a second end 65. The slab 60 is subjected to a felting step—high temperature compression for a desired time to compress the slab 60 to a consistent thickness T3, which is less than the thicknesses T1 and T2. A greater compressive force, represented by arrows 62, is required to compress the material from T1 to T3 at the first end 61 than is the compressive force, represented by arrows 64 required to compress the material from T2 to T3 at the second end 65.

The compression ratio of the foam material varies along the length of the felted foam shown in FIG. 11, with the greatest compression at the first end 61 (T1 to T3). The capillary pressure is inversely proportional to the effective capillary radius, and the effective capillary radius decreases with increasing firmness or compression. Arrow 66 in FIG. 11 represents the direction of capillary flow from the region of lower felt firmness or capillarity to higher felt firmness. Thus, if a wicking material or reservoir structure is formed with a foam having a gradient capillarity, the liquid fuel wicked into the material may be directed to flow from one region of the material with lower compression ratio to another region with higher compression ratio.

In one preferred embodiment, the wicking material of the reservoir structure is felted to a differential degree of compression from one region to another, such that the capillarity of the wicking material varies across its length. In this manner, liquids held within the wicking material may be directed to flow away from one region to another region of the wicking material. Such differential degree of felting in a wicking material within a reservoir structure adjacent to the cathode will help to draw water away from the cathode side of the fuel cell. Such differential degree of felting in a wicking material within a reservoir structure adjacent to the anode will help to draw liquid fuel into the fuel cell.

The invention has been illustrated by detailed description and examples of the preferred embodiments. Various changes in form and detail will be within the skill of persons skilled in the art. Therefore, the invention must be measured by the claims and not by the description of the examples or the preferred embodiments.

We claim:

1. A reservoir structure installed substantially adjacent to a cathode or an anode of a liquid fuel cell, comprising:
a sheet of wicking material into which a liquid wicks and from which said liquid subsequently may be metered, said wicking material having a longest dimension, and a free rise wick height of the wicking material is greater than at least one half of the longest dimension.

2. The reservoir structure of claim 1, wherein the free rise wick height of the wicking material is greater than the longest dimension.

3. The reservoir structure of claim 1, wherein the wicking material is selected from the group consisting of foam, bundled fiber and nonwoven fiber.

4. The reservoir structure of claim 1, wherein the wicking material is selected from the group consisting of polyurethane foam, felted polyurethane foam, reticulated polyurethane foam, felted reticulated polyurethane foam, melamine foam, nonwoven felts or bundles of nylon, polypropylene, polyester, cellulose, polyethylene terephthalate, polyethylene, polypropylene and polyacrylonitrile, and mixtures thereof.

5. The reservoir structure of claim 1, wherein the sheet has a thickness and defines one or more holes through said thickness.

6. The reservoir structure of claim 5, wherein the holes through the thickness of the sheet are formed by perforating the sheet.

7. The reservoir structure of claim 1, wherein the sheet has an upper surface and defines one or more channels in said upper surface.

8. The reservoir structure of claim 7, wherein the channels in the upper surface are formed by one or more methods selected from the group consisting of: cutting, scribing, thermoforming and convoluting.

9. The reservoir structure of claim 1, further comprising a conductive layer adjacent to the sheet.

10. The reservoir structure of claim 9, wherein the conductive layer is attached to a surface of the sheet.

11. The reservoir structure of claim 9, wherein the conductive layer is crimped to a surface of the sheet.

12. The reservoir structure of claim 1, further comprising a conductive layer associated with the sheet, wherein the conductive layer is selected from the group consisting of: metal screens, metal wools and expanded metal foils.

13. The reservoir structure of claim 1, further comprising a conductive layer that is a conductive coating coated onto a surface of the sheet.

14. The reservoir structure of claim 13, wherein the conductive coating is selected from the group consisting of: metals, carbons and carbon-containing materials, conductive polymers, and suspensions thereof or mixtures thereof.

15. The reservoir structure of claim 12, wherein the sheet has a first surface and a second surface and at least two edges, and the conductive layer covers at least the first surface and a portion of the second surface.

16. The reservoir structure of claim 15, wherein the conductive layer covers the at least two edges.

17. The reservoir structure of claim 1, further comprising a conductive layer associated with the sheet, wherein the conductive layer is in communication with a current circuit.

18. The reservoir structure of claim 1, wherein the sheet has gradient capillarity.

19. The reservoir structure of claim 1, wherein the sheet is formed as a composite of one or more wicking materials.

20. The reservoir structure of claim 19, wherein a first component of the composite has higher capillarity than a second component of the composite, and said first component has a longest dimension, and the free rise wick height of the first component is greater than one half of the longest dimension.

21. The reservoir structure of claim 19, wherein a first component of the composite has higher capillarity than a second component of the composite, and said first component has a longest dimension, and the free rise wick height of the first component is greater than the longest dimension.

22. In a liquid fuel cell comprising a cathode, an anode and a solid polymer electrolyte membrane, said cathode supplied with a gaseous oxidant stream, said anode supplied with a liquid fuel stream comprising fuel mixed with water, wherein said fuel is directly oxidized at said anode, and a first backing layer is provided for the anode and a second backing layer is provided for the cathode, wherein the improvement comprises:
a reservoir structure into which liquid wicks and from which said liquid may be metered installed as the backing layer for the cathode, said reservoir structure having a longest dimension and a free rise wick height greater than at least one half of the longest dimension.

23. The liquid fuel cell of claim 22, wherein the reservoir structure is formed from a wicking material selected from the group consisting of foam, bundled fiber and nonwoven fiber.

24. The liquid fuel cell of claim 23, wherein the wicking material is selected from the group consisting of polyurethane foam, felted polyurethane foam, reticulated polyurethane foam, felted reticulated polyurethane foam, melamine foam, nonwoven felts or bundles of nylon, polypropylene, polyester, cellulose, polyethylene terephthalate, polyethylene, polypropylene and polyacrylonitrile, and mixtures thereof.

25. The liquid fuel cell of claim 22, wherein the reservoir structure is formed as a sheet having a thickness and said sheet defines one or more holes through said thickness.

26. The liquid fuel cell of claim 25, wherein the holes through the thickness of the sheet are formed by perforating the sheet.

27. The liquid fuel cell of claim 22, wherein the reservoir structure is formed as a sheet having an upper surface and said sheet defines one or more channels in said upper surface.

28. The liquid fuel cell of claim 27, wherein the channels in the upper surface are formed by one or more methods selected from the group consisting of: cutting, scribing, thermoforming and convoluting.

29. The liquid fuel cell of claim 22, further comprising a conductive layer adjacent to the reservoir structure.

30. The liquid fuel cell of claim 29, wherein the conductive layer is attached to a surface of the reservoir structure.

31. The liquid fuel cell of claim 29, wherein the conductive layer is crimped to a surface of the reservoir structure.

32. The liquid fuel cell of claim 22, further comprising a conductive layer associated with the reservoir structure, wherein the conductive layer is selected from the group consisting of: metal screens, metal wools and expanded metal foils.

33. The liquid fuel cell of claim 22, further comprising a conductive layer that is a conductive coating coated onto a surface of the reservoir structure.

34. The liquid fuel cell of claim 33, wherein the conductive coating is selected from the group consisting of: metals, carbons and carbon-containing materials, conductive polymers, and suspensions thereof or mixtures thereof.

35. The liquid fuel cell of claim 32, wherein the reservoir structure has a first surface and a second surface and at least two edges, and the conductive layer covers at least the first surface and a portion of the second surface.

36. The liquid fuel cell of claim 35, wherein the conductive layer covers the at least two edges.

37. The liquid fuel cell of claim 22, further comprising a conductive layer associated with the reservoir structure, wherein the conductive layer is in communication with a current circuit.

38. The liquid fuel cell of claim 22, wherein the reservoir structure has gradient capillarity.

39. The liquid fuel cell of claim 22, wherein the reservoir structure is formed as a composite of one or more wicking materials.

40. The liquid fuel cell of claim 39, wherein a first component of the composite has higher capillarity than a second component of the composite, and said first component has a longest dimension, and the free rise wick height of the first component is greater than one half of the longest dimension.

41. The liquid fuel cell of claim 39, wherein a first component of the composite has higher capillarity than a second component of the composite, and said first component has a longest dimension, and the free rise wick height of the first component is greater than the longest dimension.

42. A water recovery system for a direct methanol fuel cell, comprising:
a reservoir structure into which water wicks and from which said water may be metered installed as a backing layer for a cathode in the fuel cell, said reservoir structure having a longest dimension and a free rise wick height greater than at least one half of the longest dimension;
a liquid flow path in communication with the reservoir structure through which absorbed water from the reservoir structure flows away from the reservoir structure; and
a pump to draw absorbed water from the reservoir structure and into the liquid flow path.

43. The water recovery system of claim 42, further comprising:
a reservoir or channel into which absorbed water passed through the liquid flow path is mixed with liquid fuel.

44. The water recovery system of claim 43, further comprising:
a second reservoir structure installed as a backing layer for an anode in the fuel cell, said second reservoir structure having a longest dimension and a free rise wick height greater than at least one half of its longest dimension.

45. The water recovery system of claim 44, further comprising:
a liquid flow path between the reservoir or channel into which the absorbed water is mixed with liquid fuel and the second reservoir structure.

46. The water recovery system of claim 42, wherein the reservoir structure is formed from a wicking material selected from the group consisting of foam, bundled fiber and nonwoven fiber.

47. The water recovery system of claim 46, wherein the wicking material is selected from the group consisting of polyurethane foam, felted polyurethane foam, reticulated polyurethane foam, felted reticulated polyurethane foam, melamine foam, nonwoven felts or bundles of nylon, polypropylene, polyester, cellulose, polyethylene terephthalate, polyethylene, polypropylene and polyacrylonitrile, and mixtures thereof.

48. The water recovery system of claim 42, wherein the reservoir structure has a thickness and defines one or more holes through said thickness.

49. The water recovery system of claim 48, wherein the holes through the thickness of the sheet are formed by perforating the reservoir structure.

50. The water recovery system of claim 42, wherein the reservoir structure is formed as a sheet having an upper surface and said sheet defines one or more channels in said upper surface.

51. The water recovery system of claim 50, wherein the channels in the upper surface are formed by one or more methods selected from the group consisting of: cutting, scribing, thermoforming and convoluting.

52. The water recovery system of claim 42, further comprising a conductive layer adjacent to the reservoir structure.

53. The water recovery system of claim 52, wherein the conductive layer is attached to a surface of the reservoir structure.

54. The water recovery system of claim 53, wherein the conductive layer is crimped to a surface of the reservoir structure.

55. The water recovery system of claim 42, further comprising a conductive layer associated with the reservoir structure, wherein the conductive layer is selected from the group consisting of: metal screens, metal wools and expanded metal foils.

56. The water recovery system of claim 42, further comprising a conductive layer that is a conductive coating coated onto a surface of the reservoir structure.

57. The water recovery system of claim 56, wherein the conductive coating is selected from the group consisting of: metals, carbons and carbon-containing materials, conductive polymers, and suspensions thereof or mixtures thereof.

58. The water recovery system claim 55, wherein the reservoir structure is a sheet having a first surface and a second surface and at least two edges, and the conductive layer covers at least the first surface and a portion of the second surface.

59. The water recovery system of claim 58, wherein the conductive layer covers the at least two edges.

60. The water recovery system of claim 42, further comprising a conductive layer associated with the reservoir structure, wherein the conductive layer is in communication with a current circuit.

61. The water recovery system of claim 42, wherein the reservoir structure has gradient capillarity.

62. The water recovery system of claim 42, wherein the reservoir structure is formed as a composite of one or more wicking materials.

63. The water recovery system of claim 62, wherein a first component of the composite has higher capillarity than a second component of the composite, and said first component has a longest dimension, and the free rise wick height of the first component is greater than one half of the longest dimension.

64. The water recovery system of claim 62, wherein a first component of the composite has higher capillarity than a second component of the composite, and said first component has a longest dimension, and the free rise wick height of the first component is greater than the longest dimension.
